(19) United States
(12) Patent Application Publication
(10) Pub. No.: US 2024/0139816 A1
(43) Pub. Date: May 2, 2024

(54) POWDER ADDITIVE MANUFACTURING APPARATUS AND MOLDING METHOD

(71) Applicant: THE JAPAN STEEL WORKS, LTD., Shinagawa-ku, Tokyo (JP)

(72) Inventor: Naoki UEDA, Shinagawa-ku, Tokyo (JP)

(21) Appl. No.: 18/280,453

(22) PCT Filed: Feb. 8, 2022
(86) PCT No.: PCT/JP2022/004969

§ 371 Date: Sep. 5, 2023

(30) Foreign Application Priority Data
Apr. 22, 2021 (JP) 2021-072291

(51) Int. Cl. B22F 12/33; B22F 10/28; B22F 12/00; B22F 12/67; B29C 64/153; B29C 64/205; B29C 64/232; B29C 64/236; B29C 64/245; B33Y 10/00; B33Y 30/00

(52) U.S. Cl. CPC B22F 12/33; B22F 10/28; B22F 12/222; B22F 12/224; B22F 12/67; B29C 64/153; B29C 64/205; B29C 64/232; B29C 64/236; B29C 64/245; B33Y 10/00; B33Y 30/00

(57) ABSTRACT

A powder additive manufacturing apparatus includes a plurality of molding stages, a stage conveyance mechanism, and a plurality of elevation control mechanisms. Each of the plurality of molding stages includes a main surface over which powder can be placed, the powder being an object to be processed. The stage conveyance mechanism conveys the plurality of molding stages in a process proceeding direction in a processing area including a plurality of processing sections in which the plurality of molding stages are arranged along the process proceeding direction. The plurality of elevation control mechanisms control heights of the plurality of molding stages, respectively, in the processing area.

### TECHNICAL FIELD

The present invention relates to a powder additive manufacturing apparatus and a molding method.

### BACKGROUND ART

In a powder additive manufacturing apparatus, a 3D (three-dimensional) molded article is obtained by spreading material powder such as a metal powder or a resin powder across a powder bed, applying a laser to the powder bed on which the powder has been spread, thereby melting and solidifying the powder (i.e., melting the powder and then letting the molten powder solidify), and stacking the solidified powder one after another.

For example, as a manufacturing procedure in a 3D metal printer, Patent Literature 1 discloses a technology in which the below-shown steps (a), (b), (c) and (d) are repeated. (a) Mixed powder consisting of base metal powder and its corresponding heterogeneous nuclear particles are charged in a powder supply tank, and then the chamber is evacuated. (b) After a molding table is lowered by one lamination pitch and a powder supply layer is raised by one lamination pitch, the mixed powder is spread across the molding table by using a blade. (c) An amount of the mixed powder corresponding to one layer is preheated, melted, and solidified by applying a laser thereto. Since only the base metal powder melts and solidifies, the heteronuclear nuclear particles act as nuclei for the solidification during the heteronuclear nuclear generation, so that equiaxed crystals are crystallized and crystal gains become finer. (d) An amount of the mixed powder corresponding to one lamination pitch is laminated (i.e., deposited) over the molded object, and then the laminated (i.e., deposited) mixed powder is preheated, melted, and solidified by applying a laser thereto.

### CITATION LIST

### Patent Literature

Patent Literature 1: Japanese Unexamined Patent Application Publication No. 2017-222899

### SUMMARY OF INVENTION

### Technical Problem

In powder additive manufacturing apparatuses, a batch method in which a desired product is manufactured by successively performing a plurality of different processes like those described above one after another in one apparatus is adopted. However, there has been a demand for a technology for improving the productivity of powder additive manufacturing methods.

The present disclosure has been made to solve the above-described problem, and an object thereof is to provide a powder additive manufacturing apparatus and the like capable of efficiently manufacturing desired products.

### Solution to Problem

A powder additive manufacturing apparatus according to the present disclosure includes a plurality of molding stages, a stage conveyance mechanism, and a plurality of elevation control mechanisms. Each of the plurality of molding stages includes a main surface over which powder can be placed, the powder being an object to be processed. The stage conveyance mechanism conveys the plurality of molding stages in a process proceeding direction in a processing area including a plurality of processing sections in which the plurality of molding stages are arranged along the process proceeding direction. The plurality of elevation control mechanisms control heights of the plurality of molding stages, respectively, in the processing area.

A molding method according to the present disclosure is a molding method performed by a powder additive manufacturing apparatus, the powder additive manufacturing apparatus comprising a plurality of molding stages each of which includes a main surface over which powder can be placed, the powder being an object to be processed, and the powder additive manufacturing apparatus being configured to successively mold molded objects in a processing area in which the plurality of molding stages are arranged along a process proceeding direction.

As a step (a), the powder additive manufacturing apparatus conveys the plurality of molding stages arranged along the process proceeding direction in the process proceeding direction.

As a step (b), the powder additive manufacturing apparatus lowers each of the plurality of molding stages.

As a step (c), the powder additive manufacturing apparatus spreads the powder across each of the plurality of molding stages.

As a step (d), the powder additive manufacturing apparatus applies laser light to the powder spread across each of the plurality of molding stages.

As a step (e), the powder additive manufacturing apparatus repeats the steps (a) to (d).

### Advantageous Effects of Invention

According to the present disclosure, it is possible to provide a powder additive manufacturing apparatus and a molding method capable of efficiently manufacturing desired products.

### BRIEF DESCRIPTION OF DRAWINGS

FIG. 1 is a side view of a powder additive manufacturing apparatus according to an embodiment;

FIG. 2 is a plan view of the powder additive manufacturing apparatus according to the embodiment;

FIG. 3 is a side view showing an example of a configuration of an optical block in a powder additive manufacturing apparatus 1;

FIG. 4 is a layout plan of horizontal guides in a processing area;

FIG. 5 is a diagram for explaining a configuration of a connection part and an elevation control mechanism;

FIG. 6 is a diagram for explaining a configuration of a molding stage;

FIG. 7 is a perspective view of a partition-plate control block;

FIG. 8 is a flowchart showing a molding method performed by a powder additive manufacturing apparatus;

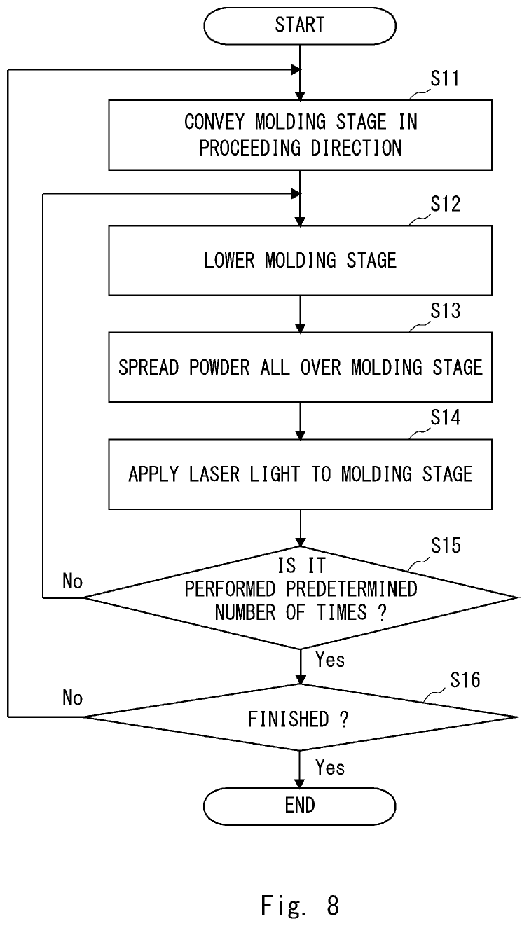

FIG. 9 is a first diagram for explaining an operation performed by a powder additive manufacturing apparatus;

FIG. 10 is a second diagram for explaining an operation performed by the powder additive manufacturing apparatus;

FIG. 11 is a third diagram for explaining an operation performed by the powder additive manufacturing apparatus;

FIG. 12 is a fourth diagram for explaining an operation performed by the powder additive manufacturing apparatus;

FIG. 13 is a fifth diagram for explaining an operation performed by the powder additive manufacturing apparatus;

FIG. 14 is a sixth diagram for explaining an operation performed by the powder additive manufacturing apparatus;

FIG. 15 is a seventh diagram for explaining an operation performed by the powder additive manufacturing apparatus;

FIG. 16 is an eighth diagram for explaining an operation performed by the powder additive manufacturing apparatus; and

FIG. 17 is a ninth diagram for explaining an operation performed by the powder additive manufacturing apparatus.

### DESCRIPTION OF EMBODIMENTS

The present invention will be described hereinafter through embodiments according to the invention, but the invention, which is specified by the claims, is not limited to the below-shown embodiments. Further, all the components/structures described in the embodiments are not necessarily indispensable as means for solving the problem. For clarifying the explanation, the following descriptions and drawings are partially omitted and simplified as appropriate. Note that the same reference numerals (or symbols) are assigned to the same elements throughout the drawings and redundant explanations thereof are omitted as appropriate.

### Embodiments

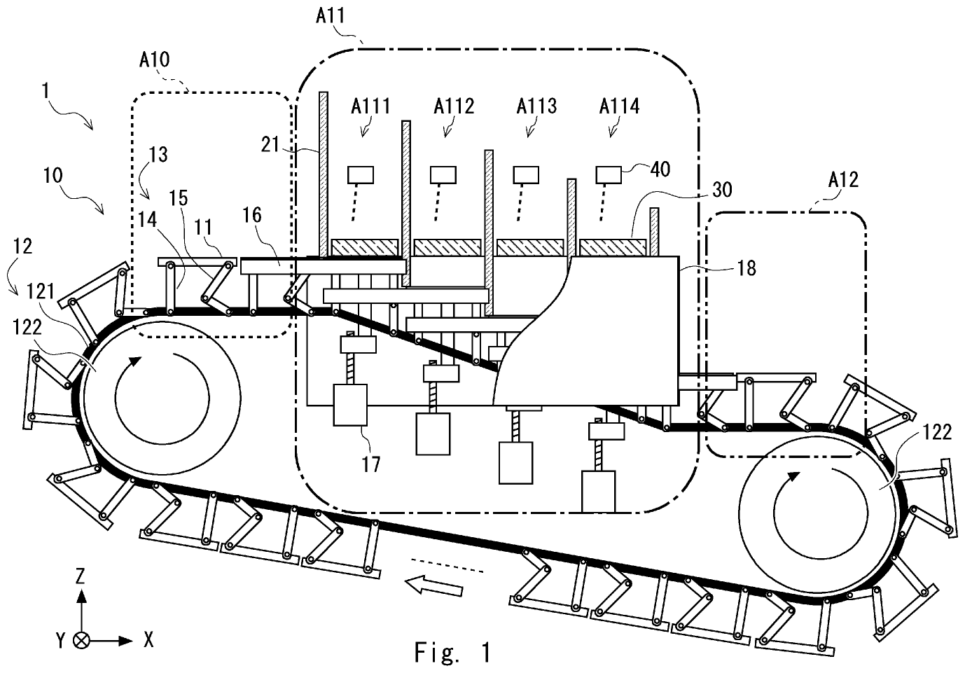

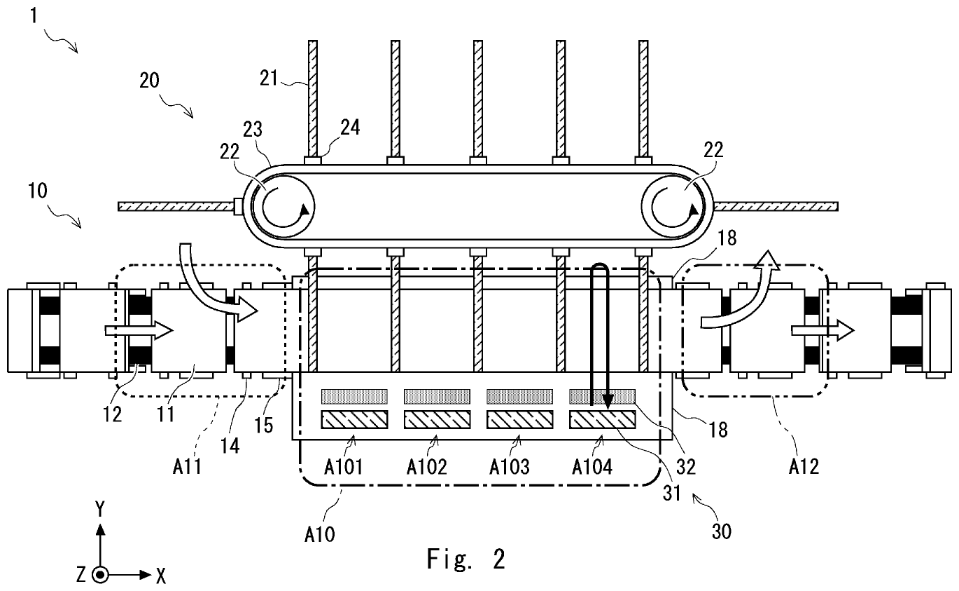

Firstly, an outline of a powder additive manufacturing apparatus according to an embodiment will be described with reference to FIGS. 1 and 2. FIG. 1 is a side view of a powder additive manufacturing apparatus according to an embodiment. FIG. 2 is a plan view of the powder additive manufacturing apparatus according to the embodiment. The powder additive manufacturing apparatus 1 according to this embodiment is a type of a so-called 3D (three-dimensional) printer, and manufactures a product to be manufactured (hereinafter referred to simply as a manufactured product) having a desired 3D shape by forming and stacking a plurality of thinly-sliced 2D (two-dimensional) layers one after another based on 3D design data. Further, the powder additive manufacturing apparatus 1 according to this embodiment is a continuous-type molding apparatus that successively manufactures manufactured products by performing a plurality of different processes (i.e., a plurality of different steps) in parallel with each other in a plurality of processing sections. Note that in FIGS. 1 and 2, some components/structures are omitted for facilitating understanding.

The powder additive manufacturing apparatus 1 includes a preheating area A10, a processing area A11, and a discharging area A12. In the preheating area A10, molding stages across each of which powder is spread are pre-heated in front of the processing area A11.

The processing area A11 is an area where powder is processed and objects having desired 3D shapes are manufactured by having each of the above-described components/structures perform its respective function. The processing area A11 includes four processing sections (a first processing section A111, a second processing section A112, a third processing section A113, and a fourth processing section A114) as shown in FIG. 2. In each of the four processing sections, a molding stage is disposed and a different process (a separate process) is performed for the disposed molding stage. More specifically, in each of the four processing sections, the powder additive manufacturing apparatus 1 forms a powder bed and applies laser light to the formed powder bed. As the molding stage passes through the four processing sections, molded blocks containing manufactured products are generated over the molding stage. The discharging area A12 is an area to which molded blocks, which have passed through the processing area A11, are conveyed and from which they are discharged.

Each of the components/structures of the powder additive manufacturing apparatus 1 will be described hereinafter. The powder additive manufacturing apparatus 1 includes, as main components, a molding block 10, a partition-plate control block 20, a powder supply block 30, and a light source block 40.

Note that in FIG. 1, a right-handed orthogonal coordinate system is shown for explaining the positional relationship among the components. Further, in FIG. 2 and the subsequent drawings, when an orthogonal coordinate system is shown, the X-, Y-, and Z-axis directions in the orthogonal coordinate system coincide with the X-, Y-, and Z-axis directions, respectively, shown in FIG. 1.

### (Molding Block 10)

The molding block 10 includes, as main components, molding stages 11, a stage conveyance mechanism 12, connection parts 13, horizontal guides 16, elevation control mechanisms 17, and side plates 18.

The molding stage 11 includes a rectangular main surface over which powder, which is an object to be processed, can be placed. The molding stages 11 are engaged with the stage conveyance mechanism 12 through the connection parts 13 and are conveyed by the stage conveyance mechanism 12. The molding stages 11 are configured so that their main surfaces face upward in the processing area A11.

The stage conveyance mechanism 12 supports a plurality of molding stages 11 through connection parts 13 and successively conveys these molding stages 11 in the process proceeding direction. The process proceeding direction is a direction from the X-axis negative side to the X-axis positive side in FIGS. 1 and 2. The stage conveyance mechanism 12 includes, as main components, a conveyance part 121 and conveyance drive units 122.

The conveyance part 121 is formed in a loop and supports molding stages 11 along the loop. Further, the conveyance part 121 is driven by the conveyance drive units 122. In this way, the conveyance part 121 conveys molding stages 11 by circulating them along the loop. The conveyance part 121 is, for example, a chain or belt formed in a loop.

Each of the conveyance drive units 122 includes a motor for driving the conveyance part 121, is engaged with the conveyance part 121, and circulates the conveyance part 121 along the loop. Only one conveyance drive unit 122 may be provided, or two or more conveyance drive units 122 may be provided. The stage conveyance mechanism 12 shown in FIG. 1 includes one conveyance drive unit 122 on each of the right and left ends of the conveyance part 121. Further, as shown in FIG. 1, each of the conveyance drive units 122 is configured to rotate rightward (i.e., clockwise) about an axis parallel to the X-axis. In this way, the conveyance drive units 122 convey the upper part of the conveyance part 121 from left to right. Further, the conveyance drive units 122 convey the lower part of the conveyance part 121 from right to left. Note that in addition to the above-described structure, the stage conveyance mechanism 12 may include a guide member(s) for regulating the movement of the conveyance part 121 or assisting the movements of the conveyance drive units 122. One of the conveyance drive units 122 shown in the drawing may a driving conveyance drive unit and the other conveyance drive unit 122 may be a follower conveyance drive unit.

The conveyance part 121 in this embodiment is configured to circulate along a vertical plane. More specifically, the conveyance part 121 shown in FIG. 1 circulates in a loop along an YZ-plane, which correspond to the vertical plane. Further, the conveyance part 121 has roughly an oval shape with circular parts at its left and right ends. Further, the stage conveyance mechanism 12 is disposed so that the height of the conveyance part 121 in the processing area A11 decreases from the upstream side of the process to the downstream side thereof. In the example shown in FIG. 1, the conveyance part 121 is conveyed from left to right by the conveyance drive units 122 in the processing area A11. Therefore, the upstream side of the process in the processing area A11 is the left side in the drawing and the downstream side of the process is the right side in the drawing. Accordingly, the height of the conveyance part 121 shown in FIG. 1 decreases from the upper left to the lower right.

Each of the horizontal guides 16 extends in the proceeding direction over two adjacent processes in the processing area A11 and guides one molding stage 11 engaged therewith in the horizontal direction. Each of the horizontal guides 16 may be formed by, for example, a linear guide. The molding block 10 includes a plurality of horizontal guides 16 in the processing area A11. The plurality of horizontal guides 16 are disposed in a cascaded manner or a stepwise manner along the conveyance part 121, which extends in an inclined direction.

Each of the elevation control mechanisms 17 is disposed in its respective process in the processing area A11 and supports a molding stage 11 conveyed to that process. Further, each of the elevation control mechanisms 17 controls the height of the molding stage 11, which is supported by that elevation control mechanism 17, in order to make its respective powder supply block 30 form a powder bed over the molding stage 11. Further, after laser light is applied to the powder spread across the molding stage 11, the elevation control mechanism 17 lowers the molding stage 11 to such a position that the molding stage 11 and the horizontal guide 16 located below the molding stage 11 can be engaged with each other.

Each of the side plates 18 includes a surface that abuts against (i.e., comes into contact with) the side of the molding stage 11 along the proceeding direction in the processing area A11. The side plate 18 supports the powder spread across the molding stage 11 by abutting against the side of the molding stage 11. Each of the side plates 18 in this embodiment extends over a plurality of adjacent processing sections, and its upper end is horizontally formed and fixed so that its position is not changed. Therefore, heights from the main surfaces of the four molding stages 11, which are conveyed by the stage conveyance mechanism 12 and disposed in the respective processing sections, to the upper ends of the side plates 18 are different from each other. That is, the side plates 18 abut against the sides of the molding stages 11 along the proceeding direction in the processing area A11, and are vertically disposed in such a manner that the heights from the main surfaces of the molding stages 11 to their upper ends can be changed. Further, the side plates 18 support the powder supply block at their upper ends.

### (Partition-Plate Control Block 20)

The partition-plate control block 20 controls the arrangement of a plurality of partition plates 21 by moving in an interlocked manner with the movement of the molding block 10. The partition-plate control block 20 includes partition plates 21, a partition-plate conveyance mechanism 22, a partition-plate conveyance belt 23, and linear guides 24.

Each of the partition plates 21 is a plate-like member disposed so as to extend in the vertical direction, and is vertically disposed along a direction perpendicular to the proceeding direction of the molding stages 11 in the processing area A11 and disposed so that the partition plate abuts against (i.e., is in contact with) the side of the molding stage 11. Further, each of the partition plates 21 is interposed between molding stages 11 adjacent thereto in the processing area A11 and moves in an interlocked manner with the movements of these molding stages 11. In this way, the partition plates 21 support the powder spread across the molding stages 11. That is, over the main surface of each of the molding stages 11, its four sides are supported by the above-described side plates 18 and the partition plates 21. In other words, the side plates 18 and the partition plates 21 form a frame over the main surface of the molding stage 11.

Further, the partition plates 21 are supported by linear guides 24 in such a manner that they can be linearly moved in the vertical direction. In this way, the partition plates 21 are disposed in a stepwise manner in the processing area A11 and follow the movements of the molding stages 11, which are conveyed in the proceeding direction while being processed.

The partition-plate conveyance mechanism 22 is composed of cylindrical rotating members each of which has a central axis extending in the vertical direction. The partition-plate conveyance mechanism 22 is engaged with the partition-plate conveyance belt 23 and support the movement of the partition-plate conveyance belt 23. Specifically, the partition-plate conveyance mechanism 22 shown in FIG. 2 is engaged with the inner sides of the circular parts at both ends of the partition-plate conveyance belt 23 having an oval shape. The partition-plate conveyance mechanism 22 may include a driving unit(s) for actively circulating the partition-plate conveyance belt 23. Alternatively, the partition-plate conveyance mechanism 22 may include no driving unit and may be configured to be interlocked with and driven by the molding block 10.

The partition-plate conveyance belt 23 is formed in a loop along the horizontal plane (XY-plane) and is supported by the partition-plate conveyance mechanism 22 so that the partition-plate conveyance belt 23 can be circulated (i.e., rotated) along the loop. A plurality of linear guides 24 are fixed on the outer periphery of the partition-plate conveyance belt 23. The partition-plate conveyance belt 23 shown in FIG. 2 has an oval shape extending in the left/right direction, and the partition-plate conveyance mechanism 22 is engaged with the inner sides of the circular parts at the left and right ends. Note that the shape of the partition-plate conveyance belt 23 is not limited to the oval shape shown in FIG. 2.

Each of the linear guides 24 includes a rail part and a movable part. The rail part is fixed to the partition-plate conveyance belt 23 in such a manner that it is parallel to the vertical direction. The movable part holds a partition plate 21 in such a manner that the partition plate can be moved in the vertical direction.

The partition-plate control block 20 has been described above. As described above, the partition-plate control block 20 supports a plurality of partition plates 21 in such a manner that they can be linearly moved in the vertical direction independently of each other. Further, the partition-plate control block 20 includes the partition-plate conveyance mechanism 22 that conveys partition plates 21 so that they are circulated in a loop along the horizontal plane.

Further, the partition-plate conveyance mechanism 22 conveys partition plates 21 along the proceeding direction in the processing area A11, and after the partition plates 21 leave the processing area A11, conveys the partition plates 21 in a direction different from the proceeding direction. Further, the partition-plate conveyance mechanism 22 moves partition plates 21 in an interlocked manner with the movements of the molding stages 11 in the processing area A11.

### (Powder Supply Block 30)

The powder supply block 30 includes, as main components, re-coaters 31 and supplied powder 32. Each of the re-coaters 31 is a member for spreading supplied powder 32 across the corresponding molding stage 11. The re-coater 31 typically has a blade-like shape or a roller-like shape. As shown in FIG. 2, the re-coater 31 is disposed over the upper surface of the side plate 18 at the side of the molding stage 11, and moves in a reciprocating manner in a direction (Y-direction) perpendicular to the proceeding direction of the molding stage 11 (i.e., perpendicular to the X-axis direction).

The supplied powder 32 is powder that is spread across the molding stage 11 by the re-coater 31. The supplied powder 32 is supplied between the re-coater 31 and the molding stage 11 by a certain supplied powder apparatus. The certain supplied powder apparatus is, for example, an apparatus that raises a predetermined amount of powder from powder stored in a lower part thereof in such a manner that the re-coater 31 can move the raised powder. Alternatively, the certain supplied powder apparatus may be, for example, an apparatus that supplies a predetermined amount of powder by dropping it from an upper part thereof onto a surface between the re-coater 31 and the molding stage 11.

As described above, the plurality of re-coaters 31 spread supplied powder 32 across the plurality of molding stages 11, respectively, in parallel with each other (e.g., simultaneously with each other) in the processing area A11. Further, the re-coaters 31 move in a reciprocating manner in the direction perpendicular to the proceeding direction (i.e., in the Y-direction in FIG. 2). In this way, the re-coaters 31 spread supplied powder 32 across the molding stages 11.

### (Light Source Block 40)

The light source block 40 shown in FIG. 1 applies laser light to the powder spread by the re-coater 31 in each of the processing sections of the processing area A11. In this way, the light source block 40 melts and solidifies the powder into a desired shape (i.e., melts the powder and then letting the molten powder solidify into a desired shape).

The outline of the powder additive manufacturing apparatus 1 has been described above. Note that in the above-described example, the powder additive manufacturing apparatus 1 includes four processing sections (first to fourth processing sections A111 to A114) in the processing area A11. However, the number of processing sections included in the processing area A11 is not limited to four. The processing area A11 needs to include at least two processing sections.

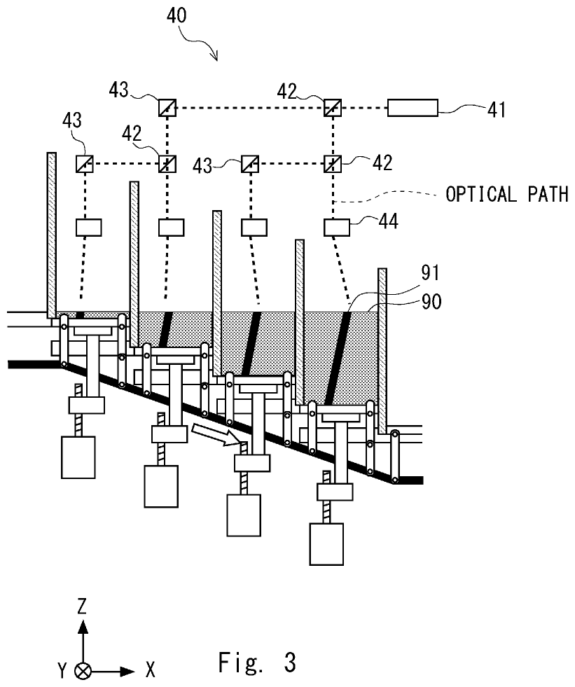

Next, an example of a configuration of the light source block 40 will be described with reference to FIG. 3. FIG. 3 is a side view showing an example of a configuration of an optical block in the powder additive manufacturing apparatus 1. FIG. 3 shows a state in which powder beds 90 are spread across the respective molding stages 11 provided in the respective processing sections in the processing area A11. Further, FIG. 3 shows a situation in which products 91 are being manufactured by having the light source block 40 apply laser light to a plurality of powder beds 90.

The light source block 40 shown in FIG. 3 includes, as main components, a laser oscillation unit 41, semi-reflection mirrors 42, total reflection mirrors 43, and galvano units 44. Each of the laser oscillation unit 41 is, for example, a laser oscillator that outputs a carbon dioxide laser. Each of the semi-reflection mirrors 42 reflects part of input laser light and lets the remaining part of the laser light pass therethrough. Each of the total reflection mirrors 43 reflects input laser light.

Each of the galvano units 44 includes a mirror that reflects input laser light at a predetermined angle and a galvano motor that drives this mirror. By the above-described configuration, products 91 are formed by having the galvano units 44 apply input laser light to the respective powder beds 90 spread across the main surfaces of the respective molding stages 11, and thereby melting and solidifying the powder into desired shapes.

By combining a plurality of semi-reflection mirrors 42 and a plurality of total reflection mirrors 43, the light source block 40 divides laser light generated by one laser oscillation unit 41 into a plurality of laser light beams and supplies the plurality of laser light beams to the galvano units 44 provided in the respective processing sections. By the above-described configuration, the light source block 40 can reduce variations in laser power applied to the plurality of different processing sections.

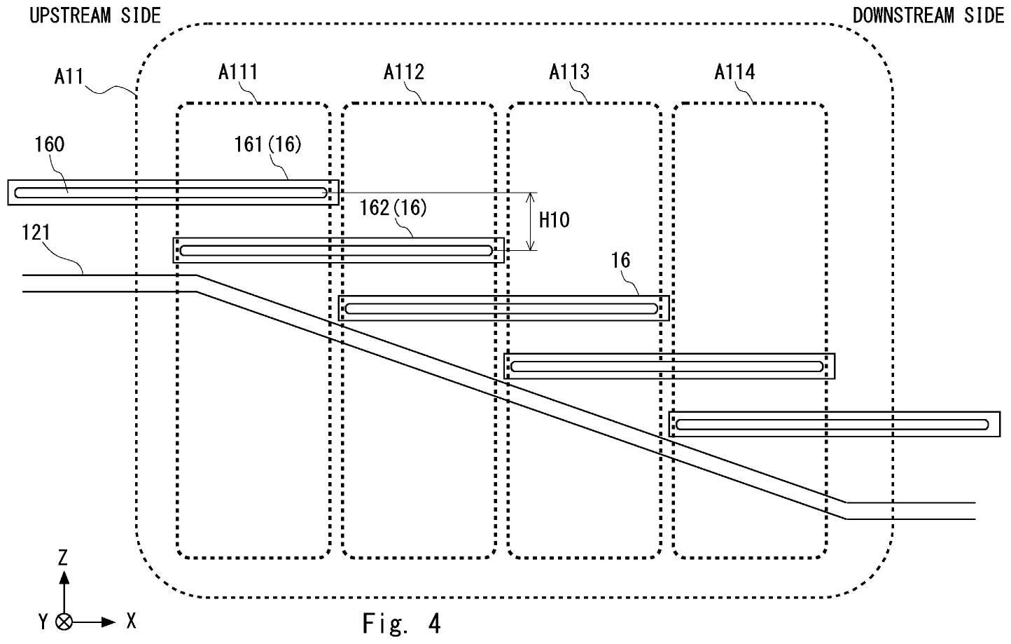

Next, an arrangement of horizontal guides will be described with reference to FIG. 4. FIG. 4 is a layout plan of horizontal guides in a processing area. FIG. 4 shows some of the conveyance parts 121 and a plurality of horizontal guides 16 fixed above the conveyance parts 121. Note that in FIG. 4, the conveyance parts 121 are conveyed from left to right. That is, the left side in FIG. 4 is the upstream side of the process, and the right side in FIG. 4 is the downstream side of the process.

As shown in the drawing, each of the horizontal guides 16 extends in the proceeding direction over two adjacent processing sections in the processing area A11. Further, each of the horizontal guides 16 includes a horizontal guide groove 160. The molding stages 11 are detachably engaged with the horizontal guide grooves 160 of the horizontal guides 16. When the molding stage 11 is engaged with the horizontal guide groove 160, the horizontal guide 16 guides the molding stage 11 engaged therewith to the adjacent processing section (i.e., to the next processing section).

Further, the horizontal guides 16 are arranged in such a manner that the upstream part of a second horizontal guide disposed on the downstream side of the process is disposed below the downstream part of a first horizontal guide disposed on the upstream side of the process. Specifically, for example, the first horizontal guide 161 and the second horizontal guide 162 are disposed in the first processing section A111. The right side (downstream part) of the first horizontal guide 161 is disposed in the first processing section A111. Further, the left side (upstream part) of the second horizontal guide 162 is disposed below the first horizontal guide 161 in the first processing section A111. Note that the distance between the first and second horizontal guides 161 and 162 is represented by H10.

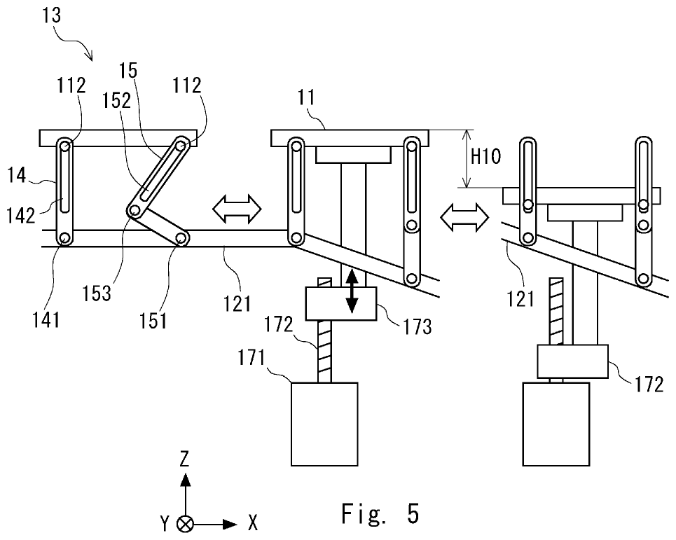

Next, the connection part 13 and the elevation control mechanism 17 will be described with reference to FIG. 5. FIG. 5 is a diagram for explaining a configuration of a connection part and an elevation control mechanism. The left side of FIG. 5 shows a state in which a connection part 13 including a folded second connection part 15 connects a molding stage 11 with a conveyance part 121. The central part of FIG. 5 shows a state in which the connection part 13 connects the molding stage 11 with the conveyance part 121 when the conveyance part 121 extends in an inclined direction in the processing area A11. The right side of FIG. 5 shows a state in which the molding stage 11 is lowered while being supported by the elevation control mechanism 17.

Firstly, the connection part 13 will be described. The connection part 13, which connects the conveyance part 121 with the molding stage 11, includes a first connection part 14 and a second connection part 15. The first connection part 14 connects the molding stage 11 with the conveyance part 121 by having its one end engaged with the molding stage 11 on the upstream side of the molding stage 11 and having the other end engaged with the conveyance part 121. The first connection part 14 includes, as main components, a first connection shaft 141 and a first guide groove 142. The first connection shaft 141 is engaged with the conveyance part 121. The first connection part 14 is rotatably supported by the conveyance part 121 around the first connection shaft 141. The first guide groove 142 is a guide groove and supports a guide shaft 112 projecting into the side of the molding stage 11 in such a manner that the guide shaft 112 can be linearly moved.

The second connection part 15 connects the molding stage 11 with the conveyance part 121 by having its one end engaged with the molding stage 11 on the downstream side of the molding stage 11 and having the other end engaged with the conveyance part 121. The second connection part 15 includes, as main components, a second connection shaft 151, a second guide groove 152, and a joint part 153. The second connection shaft 151 is engaged with the conveyance part 121.

The second connection part 15 is rotatably supported by the conveyance part 121 around the second connection shaft 151. The second guide groove 152 is a guide groove and supports a guide shaft 112 projecting into the side of the molding stage 11 in such a manner that the guide shaft 112 can be linearly moved. The joint part 153 is a joint provided between the second connection shaft 151 and the second guide groove 152 and is configured so that the shape of the second connection part 15 can be changed into a folded state or a straight state. The second connection part 15 may include a locking mechanism for maintaining the folded state or the straight state.

As shown on the left side of the drawing, the connection part 13 folds the joint part 153 of the second connection part 15 when the conveyance part 121 extends in the horizontal direction. Further, as shown in the central part of the drawing, the connection part 13 becomes an extended state in which the joint part 153 is not folded when the conveyance part 121 extends in an inclined direction. By changing the state of the second connection part 15 according to the direction in which the conveyance part 121 extends as described above, the connection part 13 can keep the posture of the molding stage 11 parallel to the horizontal plane irrespective of whether the conveyance part 121 horizontally extends or extends in an inclined direction. Further, as shown on the right side of the drawing, the connection part 13 is configured so that the molding stage 11 can be lowered by a distance corresponding to the height H10 while maintaining the posture of the molding stage 11 parallel to the horizontal plane. By the above-described configuration, the connection part 13 is connected to each of the conveyance part 121 and the molding stage 11 in the processing area A11 in such a manner that the relative positional relationship therebetween in the vertical direction can be changed.

Next, the elevation control mechanism 17 will be described. The elevation control mechanism 17 includes, as main components, an elevation motor 171, a drive shaft 172, and an elevation block 173. The elevation motor 171 rotates the drive shaft 172 with a spiral groove formed thereon in a desired direction. The drive shaft 172 is a shaft that is rotated by the elevation motor 171 and is engaged with the drive shaft 172. The elevation block 173 is engaged with the drive shaft 172 and supports the lower part of the molding stage 11.

For example, the elevation control mechanism 17 raises the elevation block 173 by having the elevation motor 171 rotate the drive shaft 172 clockwise. Further, the elevation control mechanism 17 lowers the elevation block 173 by having the elevation motor 171 rotate the drive shaft 172 counterclockwise. As described above, when the elevation block 173 supports the molding stage 11, the elevation control mechanism 17 controls the height of the molding stage 11 according to the above-described movement.

By the above-described configuration, the elevation control mechanism 17 is disposed so that it can perform a lifting/lowering operation between the first horizontal guide 16 disposed on the upstream side of the process in the processing section (e.g., the first horizontal guide 161 in FIG. 4) and the second horizontal guide 16 disposed on the downstream side thereof (e.g., the second horizontal guide 162 in FIG. 4). In this way, the elevation control mechanism 17 lowers the molding stage 11, which has left (has been disengaged from) the first horizontal guide 16, in such a manner that the molding stage 11 can be engaged with the second horizontal guide 16.

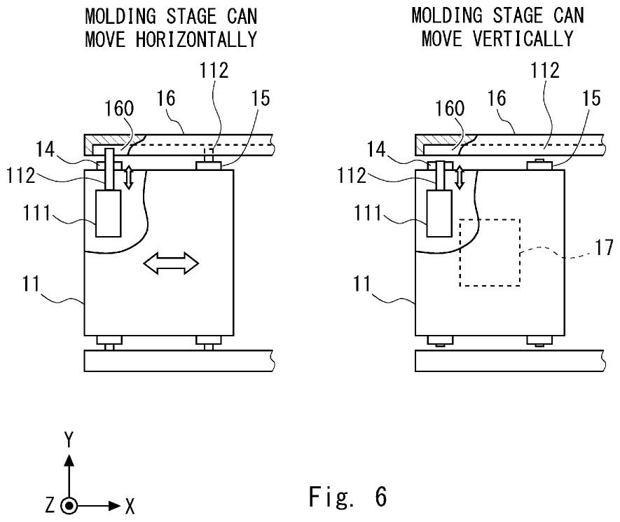

Next, a configuration of the molding stage 11 will be described with reference to FIG. 6. FIG. 6 is a diagram for explaining a configuration of a molding stage. In FIG. 6, two molding stages 11 each of which is interposed between two opposed horizontal guides 16 are shown in the right and left sides, respectively. A part of each of the molding stages 11 is shown in a see-through manner for facilitating understanding. The molding stage 11 includes plungers 111 and guide shafts 112.

Each of the plunger 111 extends or retracts the respective guide shaft 112 in the axial direction by driving the guide shaft 112. The molding stage 11 includes two plungers 111, which are spaced apart in the front/rear direction, at each of both sides of the molding stage 11 (each of both sides in the Y direction). That is, the molding stage 11 includes four plungers 111 in total. Further, the guide shafts 112, which are driven by the respective plungers 111, are engaged with the first and second connection parts 14 and 15, respectively.

The molding stage 11 shown on the left side of FIG. 6 is in a state in which each of the four plungers 111 has extended the respective guide shaft 112. As the guide shaft 112 is extended by the plunger 111, it is engaged with the horizontal guide groove 160 formed in the horizontal guide 16. In this case, the molding stage 11 is guided by the horizontal guide 16, so that it can move in the horizontal direction while maintaining the posture in which the main surface is parallel to the horizontal plane. However, in this case, the molding stage 11 cannot move in the vertical direction because it is restrained by the horizontal guide groove 160.

The molding stage 11 shown on the right side of FIG. 6 is in a state in which each of the four plungers 111 has retracted the respective guide shaft 112. As the guide shaft 112 is pulled into plunger 111, it leaves (i.e., is disengaged from) the horizontal guide groove 160. In this case, the molding stage 11 can move up and down while being guided by the first and second connection parts 14 and 15. Note that in this case, as indicated by a dotted line on the right side of FIG. 6, the molding stage 11 is supported by the elevation control mechanism 17 from below, so that it moves in the vertical direction.

The configuration of the molding stage 11 has been described above. As described above, the molding stage 11 in this embodiment is detachably engaged with the horizontal guide 16. In this way, the powder additive manufacturing apparatus 1 controls the positions and postures of a plurality of molding stages 11.

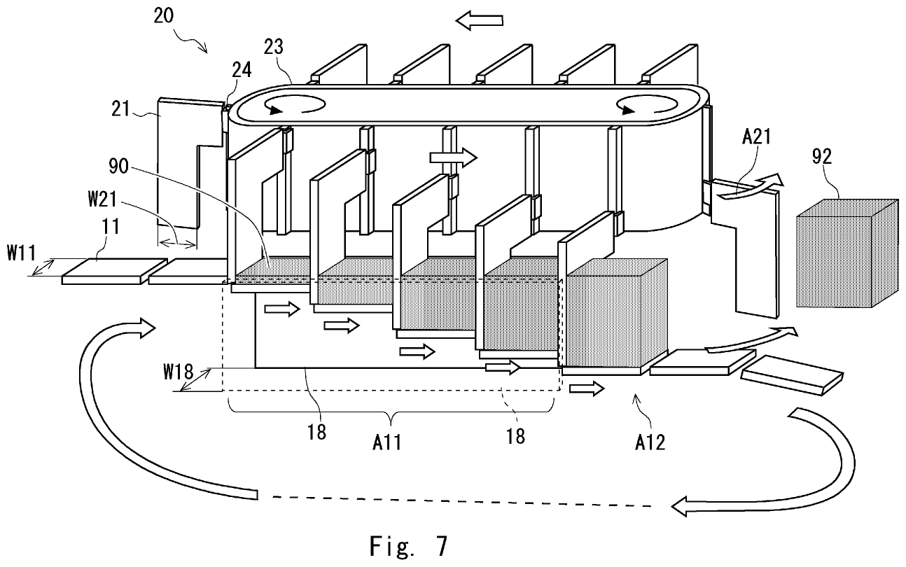

Next, the partition-plate control block will be described with reference to FIG. 7. FIG. 7 is a perspective view of a partition-plate control block. In the partition-plate control block 20 shown in FIG. 7, the partition-plate conveyance belt 23 circulates (i.e., rotates) counterclockwise in a loop as viewed from above. On the outer periphery of the partition-plate conveyance belt 23, a plurality of linear guides 24 are fixed along the vertical direction. Each of the linear guides 24 includes a partition plate 21 that can linearly move in the vertical direction. The partition-plate conveyance belt 23 circulates in a loop according to the movements of the molding stages 11. In this way, the partition plates 21 move in an interlocked manner with the molding stages 11.

Each of the molding stages 11 passes between two opposed side plates 18. Note that the distance between the two side plates 18 is defined as a distance W18. Further, the molding stage 11, which passes through space having the distance W18, has a width W11. Note that the width W11 is such a width that the molding stage 11 can pass through the space having the distance W18 without rattling. Further, the partition plate 21 has a width W21 as a dimension of the part that abuts against the molding stage 11. Note that the width W11 of the molding stage 11 and the width W21 of partition plate 21 are roughly equal to each other. Therefore, the powder beds 90 formed in the processing area A11 are successively conveyed in the process proceeding direction while remaining in the state in which each of them is surrounded and supported by the side plates 18 and partition plates 21.

The powder processed in the processing area A11 forms a powder block 92 having a rectangular columnar shape. After passing the processing area A11, the powder block 92 is conveyed to the discharging area A12. In the discharging area A12, the powder block 92 leaves the molding stage 11 because the side plates 18 are no longer present and the partition plates 21 on the downstream side of the process moves along the partition-plate conveyance belt 23. Therefore, in the discharging area A12, although the powder block 92 abuts against the partition plate 21 that is located on the upstream side of the process, the other outer peripheral surfaces of the powder block 92 are not supported. Then, when the molding stage 11 and the partition plate 21 move further in the proceeding direction from this state, the partition plate 21 moves along the partition-plate conveyance belt 23 in a direction indicated by an arrow A21 while rotating. As a result, the powder block 92 is pushed out by the rotating partition plate 21 in a direction different from the proceeding direction of the molding stage 11. As described above, the partition plate 21 has a function of discharging (i.e., pushing out) the processed powder block 92 in the discharging area A12.

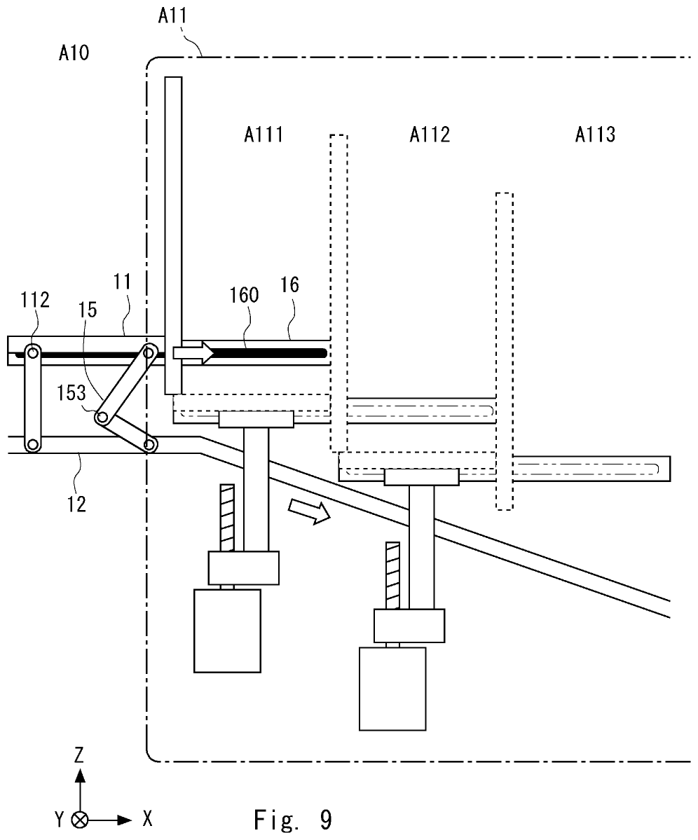

Next, processes performed by the powder additive manufacturing apparatus 1 will be described with reference to FIG. 9. FIG. 9 is a flowchart showing a molding method performed by the powder additive manufacturing apparatus. The flowchart shown in FIG. 9 shows processes performed by the powder additive manufacturing apparatus 1 in the processing area A11. The molding method according to the present disclosure is a molding method performed by a powder additive manufacturing apparatus, the powder additive manufacturing apparatus comprising a plurality of molding stages each of which includes a main surface over which powder can be placed, the powder being an object to be processed, and the powder additive manufacturing apparatus being configured to successively mold molded objects in a processing area in which the plurality of molding stages are arranged along a process proceeding direction.

Firstly, as a step (a), the powder additive manufacturing apparatus 1 conveys the plurality of molding stages 11 arranged along the process proceeding direction in the process proceeding direction (Step S11).

Next, as a step (b), the powder additive manufacturing apparatus 1 lowers each of the plurality of molding stages 11 (Step S12).

Next, as a step (c), the powder additive manufacturing apparatus 1 spreads the powder across each of the plurality of molding stages 11 (Step S13).

Next, as a step (d), the powder additive manufacturing apparatus 1 applies laser light to the powder spread across each of the plurality of molding stages 11 (Step S14).

Next, the powder additive manufacturing apparatus 1 determines whether or not the steps (b) to (d) have been performed a predetermined number of times (Step S15). That is, the powder additive manufacturing apparatus 1 performs the steps (b) to (d) the predetermined number of times. The predetermined number of times may be once, or twice or more times. When it is not determined that the steps (b) to (d) have been performed the predetermined number of times (Step S15: No), the powder additive manufacturing apparatus 1 returns to the step S12 and performs the step (b). On the other hand, when it is determined that the steps (b) to (d) have been performed the predetermined number of times (Step S15: Yes), the powder additive manufacturing apparatus 1 proceeds to a step S16.

Next, the powder additive manufacturing apparatus 1 determines whether or not to finish the series of processes (Step S16). In other words, when the powder additive manufacturing apparatus 1 has not determined that the series of processes should be finished (Step S16: No), it repeats the steps (a) to (d). Then, when the powder additive manufacturing apparatus 1 has determined that the series of processes should be finished (Step S16: Yes), the powder additive manufacturing apparatus 1 finishes the series of processes. The series of processes is finished, for example, when an instruction to stop the processes has been received from a user is or when powder to be spread across the powder bed has not been supplied.

The processes performed by the powder additive manufacturing apparatus 1 have been described above. According to the above-described powder additive manufacturing method, it is possible to efficiently manufacture desired products.

Next, the above-described powder additive manufacturing method will be described by using specific examples. FIG. 9 is a first diagram for explaining an operation performed by the powder additive manufacturing apparatus. In FIG. 9, a molding stage 11 indicated by a solid line is located at the preheating area A10. In the following descriptions, in order to focus on the operation performed by one molding stage 11, one molding stage 11 of interest is indicated by the solid line, and other molding stages 11 and the like are indicated by dotted lines. Further, some structures and the like are omitted in the drawing for facilitating understanding.

The molding stage 11 shown by the solid line in FIG. 9 is conveyed from the preheating area A10 to the processing area A11 by the stage conveyance mechanism 12 (Step (a)). At this point, the guide shaft 112 is engaged with the horizontal guide groove 160. Therefore, the molding stage 11 is conveyed to the first processing section A111 while maintaining the main surface in the horizontal state. Note that at this point, the joint part 153 of the second connection part 15 engaged with the molding stage 11 is in a folded state.

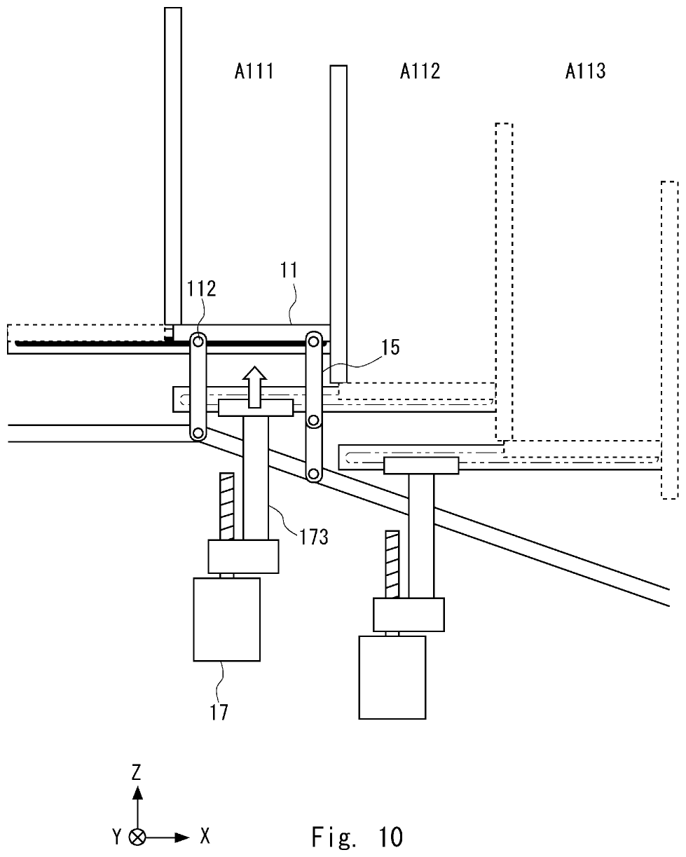

FIG. 10 is a second diagram for explaining an operation performed by the powder additive manufacturing apparatus. In FIG. 10, the molding stage 11 has already reached the first processing section A111. At this point, the guide shaft 112 is engaged with the horizontal guide groove 160. Further, the second connection part 15 has already changed from the folded state to an extended state.

When the molding stage 11 reaches the first processing section A111, the elevation control mechanism 17 provided in the first processing section A111 raises the elevation block 173 in order to support the molding stage 11. Note that the elevation control mechanism 17 may start raising the elevation block 173 before the molding stage 11 reaches the first processing section A111.

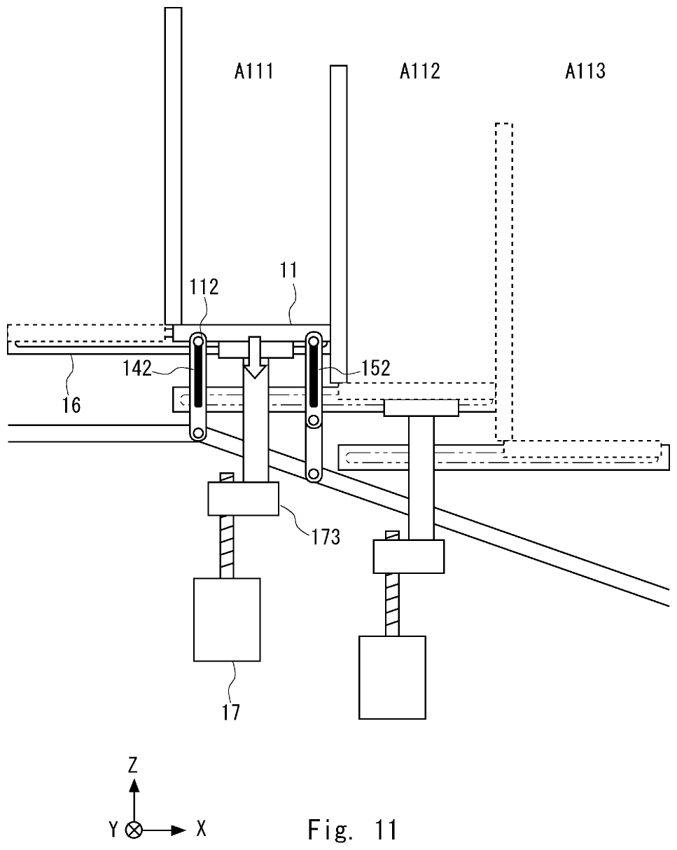

FIG. 11 is a third diagram for explaining an operation performed by the powder additive manufacturing apparatus. In FIG. 11, the molding stage 11 is supported by the elevation control mechanism 17. Further, the guide shaft 112 has already left (i.e., has already been disengaged from) the horizontal guide 16. Therefore, the molding stage 11 is in a state in which it can move in the vertical direction. From this state, the elevation block 173 is lowered. As a result, the molding stage 11 is lowered together with the elevation block 173 along the first and second guide grooves 142 and 152.

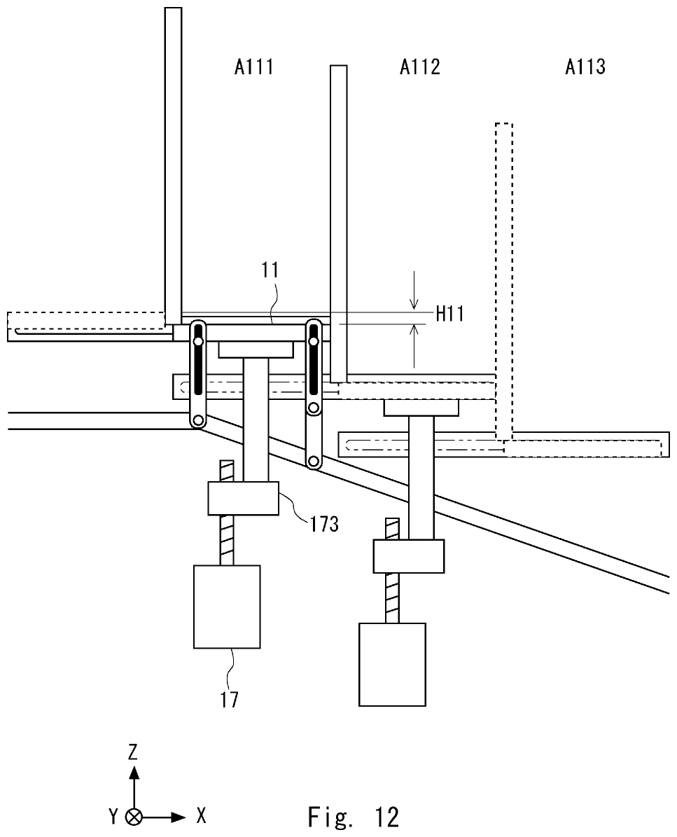

FIG. 12 is a fourth diagram for explaining an operation performed by the powder additive manufacturing apparatus. In FIG. 12, the molding stage 11 has already been lowered from the position shown in FIG. 11 by a distance corresponding to the height H11 (Step (b)). The height H11 corresponds to the thickness of the powder bed that will be generated after this operation.

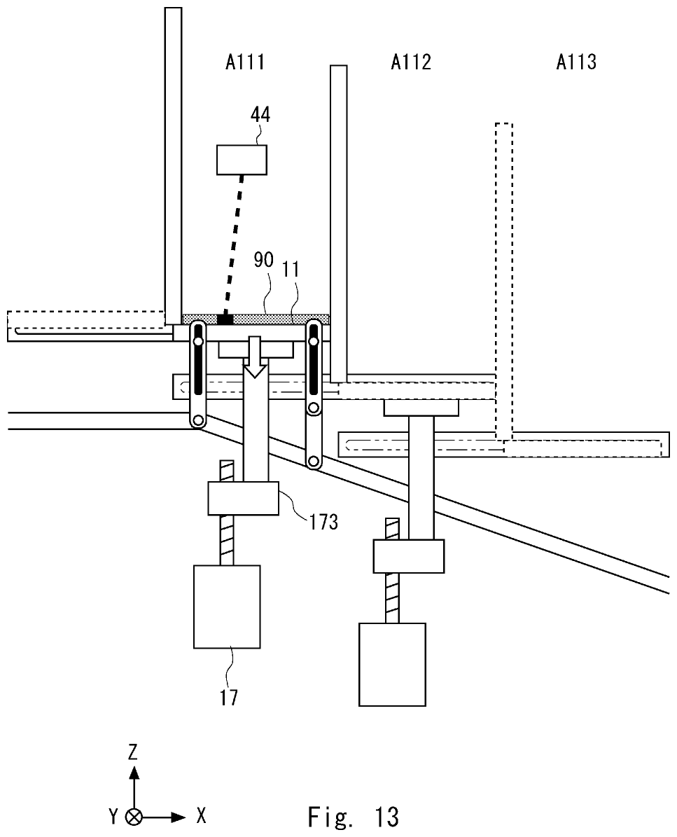

FIG. 13 is a fifth diagram for explaining an operation performed by the powder additive manufacturing apparatus. In FIG. 13, the powder bed 90 has already been spread across the main surface of the molding stage 11 (Step (c)), and laser light is being applied from the galvano unit 44 (Step (d)). When the processing of the powder bed by the laser light is finished, the elevation control mechanism 17 lowers it by the distance corresponding to the height H11 again (Step (b)). Then, the galvano unit 44 applies laser light to the powder bed (Steps (c) and (d)). The powder additive manufacturing apparatus 1 repeats the above-described series of processes a predetermined number of times.

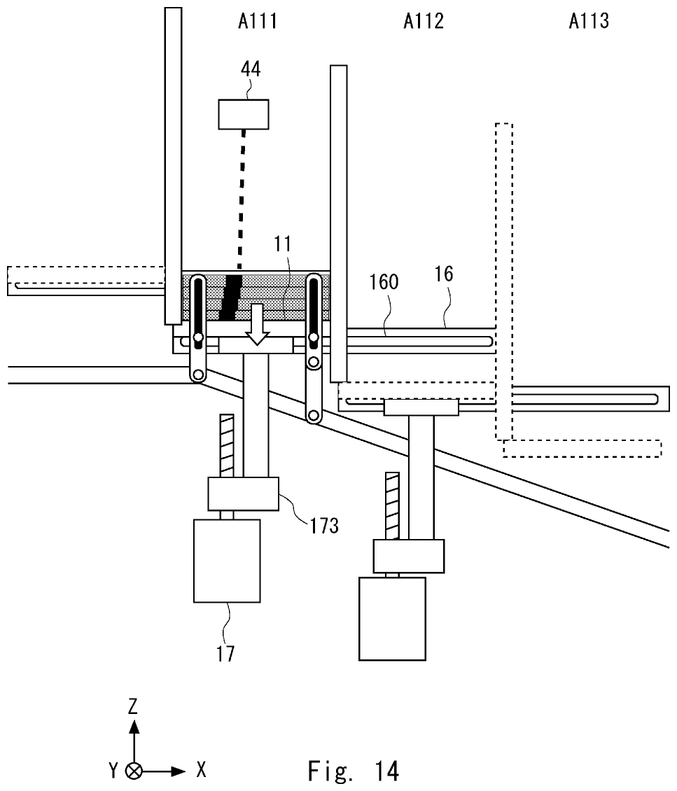

FIG. 14 is a sixth diagram for explaining an operation performed by the powder additive manufacturing apparatus. The molding stage 11 shown in FIG. 14 is in a state in which the steps (b) to (d) have already been performed the predetermined number of times. After this state, the elevation control mechanism 17 moves the molding stage 11 to a position where the guide shaft 112 can be engaged with the horizontal guide groove 160 in order to engage the molding stage 11 with the horizontal guide 16 located on the downstream side of the process.

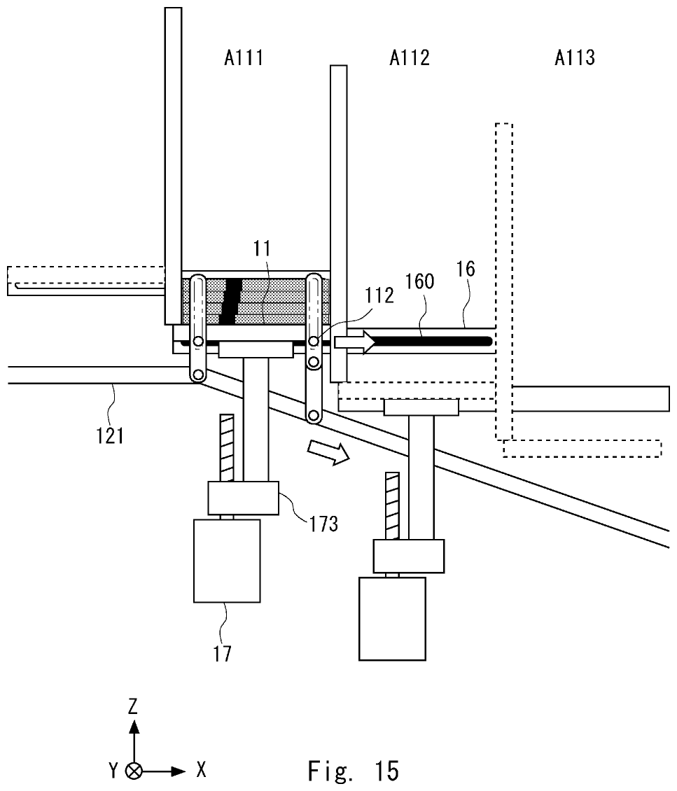

FIG. 15 is a seventh diagram for explaining an operation performed by the powder additive manufacturing apparatus. In FIG. 15, the molding stage 11 is in a state in which the guide shaft 112 is engaged with the horizontal guide groove 160. Therefore, after this state, the stage conveyance mechanism 12 conveys the molding stage 11 from the first processing section A111 to the second processing section A112 by driving the conveyance part 121 in order to make the molding stage 11 undergo the next step (Step (a)).

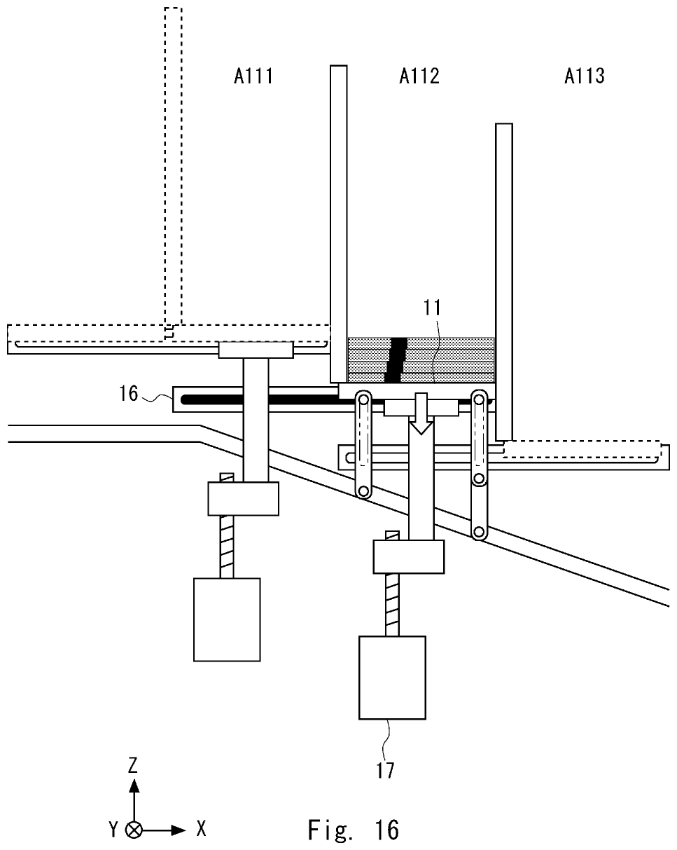

FIG. 16 is an eighth diagram for explaining an operation performed by the powder additive manufacturing apparatus. In FIG. 16, the molding stage 11 is in a state in which it has already been conveyed to the second processing section A112. After this state, the molding stage 11 is disengaged from the engagement with the horizontal guide 16. Further, the molding stage 11 is lowered by the elevation control mechanism 17 (Step (b)). Then, the powder supply block 30 generates a powder bed over the main surface of the molding stage 11 (Step (c)). Then, the galvano unit 44 applies laser light to the powder bed (Step (d)).

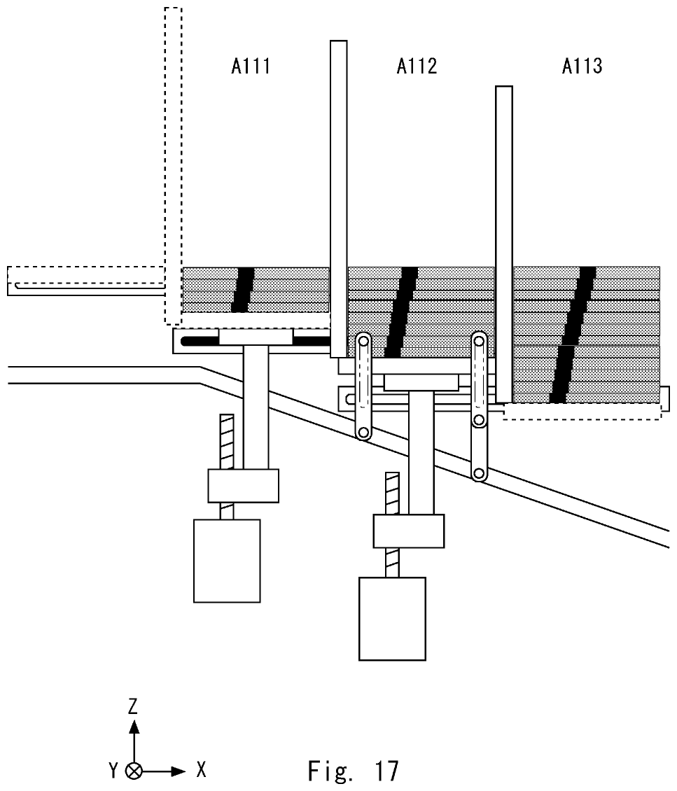

FIG. 17 is a ninth diagram for explaining an operation performed by the powder additive manufacturing apparatus. In FIG. 17, the molding stage 11 is in a state in which the predetermined process has already been performed in the second processing section A112. Therefore, in the second processing section A112, another powder bed has already been deposited over the molded object formed in the first processing section A111 over the molding stage 11, and the molded object is further formed (i.e., another layer is formed over the original molded object) by laser light. When the process in the second processing section A112 is finished, the molding stage 11 is conveyed to the third processing section A113, and a series of processes similar to the above-described series of processes is repeated. Further, as shown in FIG. 17, the processes in the plurality of processing sections are performed in parallel with each other. Therefore, the powder additive manufacturing apparatus 1 can successively manufacture desired products.

Although the powder additive manufacturing apparatus 1 has been described above, the configuration of the powder additive manufacturing apparatus 1 according to the embodiment is not limited to the above-described configuration. For example, the conveyance parts 121 provided in the stage conveyance mechanism 12 do not necessarily have to circulate along the vertical plane but may circulate along the horizontal plane. Further, the elevation control mechanisms 17 may not be fixed to the respective processing sections and may move in the proceeding direction in an interlocked manner with the molding stages 11. Further, the conveyance parts 121 may convey the elevation control mechanisms 17.

The side plates 18 may not be fixed to the processing area A11, but may be configured so that they can move up and down so as to follow the movements of the respective molding stages 11. The partition plates 21 may not be controlled by the partition-plate control block 20, but may be engaged with the molding stages 11 and may be conveyed together with the molding stages 11. The light source block 40 may not generate a plurality of laser light beams by dividing laser light emitted from one laser light source, but may have a dedicated light source for each of the processing sections.

As described above, according to the embodiment, it is possible to provide a powder additive manufacturing apparatus and a molding method capable of efficiently manufacturing desired products.

Note that the present invention is not limited to the above-described example embodiments, and they can be modified as appropriate without departing from the scope and spirit of the invention.

This application is based upon and claims the benefit of priority from Japanese patent application No. 2021-072291, filed on Apr. 22, 2021, the disclosure of which is incorporated herein in its entirety by reference.

### REFERENCE SIGNS LIST

1 POWDER ADDITIVE MANUFACTURING APPARATUS
10 MOLDING BLOCK
11 MOLDING STAGE
12 STAGE CONVEYANCE MECHANISM
13 CONNECTION PART
14 FIRST CONNECTION PART
15 SECOND CONNECTION PART
16 HORIZONTAL GUIDE
17 ELEVATION CONTROL MECHANISM
18 SIDE PLATE
20 PARTITION-PLATE CONTROL BLOCK
21 PARTITION PLATE
22 PARTITION-PLATE CONVEYANCE MECHANISM
23 PARTITION-PLATE CONVEYANCE BELT
24 LINEAR GUIDE
30 POWDER SUPPLY BLOCK
31 RE-COATER
32 SUPPLIED POWDER
40 LIGHT SOURCE BLOCK
41 LASER OSCILLATION UNIT
42 SEMI-REFLECTION MIRROR
43 TOTAL REFLECTION MIRROR
44 GALVANO UNIT
90 POWDER BED
91 PRODUCT
92 POWDER BLOCK
111 PLUNGER
112 GUIDE SHAFT
121 CONVEYANCE PART
122 CONVEYANCE DRIVE UNIT
141 FIRST CONNECTION SHAFT
142 FIRST GUIDE GROOVE
151 SECOND CONNECTION SHAFT
152 SECOND GUIDE GROOVE
153 JOINT PART
160 HORIZONTAL GUIDE GROOVE
171 ELEVATION MOTOR
172 DRIVE SHAFT
173 ELEVATION BLOCK
A11 PROCESSING AREA

1. A powder additive manufacturing apparatus comprising:
a plurality of molding stages each including a main surface over which powder can be placed, the powder being an object to be processed;
a stage conveyance mechanism configured to convey the plurality of molding stages in a process proceeding direction in a processing area including a plurality of processing sections in which the plurality of molding stages are arranged along the process proceeding direction; and
a plurality of elevation control mechanisms configured to control heights of the plurality of molding stages, respectively, in the processing area.

2. The powder additive manufacturing apparatus according to claim 1, wherein the stage conveyance mechanism comprises: a conveyance part formed in a loop and configured to circulate and convey the molding stages in the loop; and a conveyance drive unit configured to drive the conveyance part.

3. The powder additive manufacturing apparatus according to claim 2, wherein the stage conveyance mechanism is configured so that the conveyance part circulates along a vertical plane.

4. The powder additive manufacturing apparatus according to claim 2, wherein the stage conveyance mechanism is disposed so that a height of the conveyance part in the processing area decreases from an upstream side of a process to a downstream side thereof.

5. The powder additive manufacturing apparatus according to claim 2, further comprising a connection part configured to be connected to each of the conveyance part and the molding stage so that the conveyance part and the molding stage move in an interlocked manner in the process proceeding direction in the processing area.

6. The powder additive manufacturing apparatus according to claim 5, wherein the connection part is connected to each of the conveyance part and the molding stage in such a manner that a relative positional relationship therebetween in a vertical direction can be changed in the processing area.

7. The powder additive manufacturing apparatus according to claim 5, wherein the connection part comprises a joint part configured to fold between a part that is connected to the conveyance part and a part that is connected to the molding stage.

8. The powder additive manufacturing apparatus according to claim 1, further comprising a plurality of horizontal guides, each of the plurality of horizontal guides extending in the process proceeding direction over two adjacent processing sections in the processing area and configured to guide one of the molding stages in a horizontal direction.

9. The powder additive manufacturing apparatus according to claim 8, wherein the horizontal guides are arranged in such a manner that an upstream part of a second horizontal guide disposed on a downstream side of a process is disposed below a downstream part of a first horizontal guide disposed on an upstream side of the process.

10. The powder additive manufacturing apparatus according to claim 8, wherein the molding stages are detachably engaged with the horizontal guides.

11. The powder additive manufacturing apparatus according to claim 8, wherein the elevation control mechanism is disposed so that the elevation control mechanism can perform a lifting/lowering operation between a first horizontal guide disposed on an upstream side of a process in the processing area and a second horizontal guide disposed on a downstream side thereof, and configured to lower the molding stage, which has left the first horizontal guide, so that the molding stage can be engaged with the second horizontal guide.

12. The powder additive manufacturing apparatus according to claim 1, further comprising:
a side plate configured to abut against a side of the molding stage along the process proceeding direction in the processing area, the side plate being vertically disposed so that a height from the main surface of the molding stage to an upper end of the side plate can be changed; and
a partition plate vertically disposed along a direction perpendicular to the process proceeding direction in the processing area and disposed so that the partition plate abuts against a side of the molding stage, wherein
the side plate and the partition plate form a frame that supports the powder spread across the molding stage.

13. The powder additive manufacturing apparatus according to claim 12, wherein the side plate extends over a plurality of adjacent processes, and the upper end of the side plate is horizontally formed.

14. The powder additive manufacturing apparatus according to claim 12, further comprising a partition-plate conveyance mechanism configured to support a plurality of partition plates in such a manner that they can move in a vertical direction independently of each other, and convey the partition plates so that the partition plates circulate in a loop along a horizontal plane.

15. The powder additive manufacturing apparatus according to claim 14, wherein the partition-plate conveyance mechanism conveys the partition plates along the process proceeding direction in the processing area and conveys, after the partition plates leave the processing area, the partition plates in a direction different from the process proceeding direction.

16. The powder additive manufacturing apparatus according to claim 14, wherein the partition-plate conveyance mechanism moves the partition plates in an interlocked manner with movements of the molding stages in the processing area.

17. The powder additive manufacturing apparatus according to claim 1, further comprising a plurality of re-coaters, the re-coaters being configured to spread powder across the plurality of molding stages, respectively, in parallel with each other in the processing area.

18. The powder additive manufacturing apparatus according to claim 17, wherein the re-coaters spread the powder across the molding stages by moving in a reciprocating manner in a direction perpendicular to the process proceeding direction.

19. A molding method performed by a powder additive manufacturing apparatus, the powder additive manufacturing apparatus comprising a plurality of molding stages each including a main surface over which powder can be placed, the powder being an object to be processed, and the powder additive manufacturing apparatus being configured to successively mold molded objects in a processing area in which the plurality of molding stages are arranged along a process proceeding direction,
the molding method comprising the steps of:
(a) conveying the plurality of molding stages arranged along the process proceeding direction in the process proceeding direction;
(b) lowering each of the plurality of molding stages;
(c) spreading the powder across each of the plurality of molding stages;
(d) applying a laser to the powder spread across each of the plurality of molding stages; and
(e) repeating the steps (a) to (d).

20. The molding method according to claim 19, wherein the steps (b) to (d) are repeated a predetermined number of times.
